(19) United States
(12) Patent Application Publication
(10) Pub. No.: US 2004/0121142 A1
(43) Pub. Date: Jun. 24, 2004

(54) Oil absorbent wipe with high crumpability

(76) Inventors: Shinji Kimura, Sagamihara (JP); James S. Mrozinski, Oakdale, MN (US); Robert M. Floyd, Maplewood, MN (US); Jayshree Seth, Woodbury, MN (US)

Correspondence Address: 3M INNOVATIVE PROPERTIES COMPANY, PO BOX 33427, ST. PAUL, MN, 55133-3427, US

(21) Appl. No.: 10/328,676

(22) Filed: Dec. 23, 2002

(51) Int. Cl. B32B 3/26

(52) U.S. Cl. 428/315.7; 428/315.5; 428/317.9

(57) ABSTRACT

There is provided an oil absorbing wipe material suitable for wiping a users' skin or hair and a method for their manufacture. The wipes comprise at least an oil absorbing porous film-like substrate of a crystalline thermoplastic material with at least 40 percent by weight of a nonparticulate filler. Generally, the wipe changes transparency or color (a change in L* of about 10 or more) when loaded with oil to provide an oil absorption indication functionality. The wipe is capable of forming a compact ball by crumpling to a diameter of 2.5 cm or less.

### BACKGROUND OF THE INVENTION

This invention relates to oil absorbent skin wipe products. The invention particularly relates to oil absorbent skin wiping products with an oil absorption indication function.

A significant amount of oil continuously oozes out of the skin of the face, particularly the nose, cheek and forehead. To maintain cleanliness, reduce shine and to improve the spreadability of cosmetics and other skin products it is important to remove any excess surface oil or sebum. Soap and water work to some extent but there are always times when one is not able to wash. Dry methods of removing these facial oils include the use of thin oil absorbent wipe materials. Oil absorbing wipes for removing facial oil have been described in the art. These wipes generally must be thin, conformable and non-abrasive, considerations not relevant to industrial oil absorbent materials. It is also important that these wipes have the ability to crumple for ease of disposal following use. Generally, the user will crumple the wipe in his or her hand and throw it out. It is much more difficult to dispose of the wipes if they do not crumple. Paper wipes generally have the ability to crumple, but are deficient in oil removal properties.

Conventional paper type wipes have been used to remove facial oil. For example, natural or synthetic papers using vegetable fibers, synthetic pulp or kenaf have been used. These oil absorbent papers however are often irritating to the skin due to the hard and stiff nature of the fibers. To improve their smoothness, these papers have been continuously calendered and/or coated with powders such as calcium carbonate and sizing agents. Calendering however is not necessarily permanent and surface fibers can reform into a rough surface unless substantial amounts of binder or sizing agents are used, which decrease oil absorption. Paper wipes are also poor indicators as to their effectiveness, as papers generally do not significantly change appearance when they have absorbed oil or sebum.

Improvements to oil absorbing papers are described in Japanese Kokai No. 4-45591 which teaches adhering porous spherical beads onto the surface of an oil absorbing paper so as to solve the problems caused by calendering or coating of paper with powders such as calcium carbonate powders. These beads also are used to allegedly increase the capacity of the papers to absorb sebum. Japanese Unexamined Patent Publication (Kokai) No. 6-319664 discloses a high-density oil absorbing paper produced by mixing (a) a pulp material containing vegetable fibers, as the main component with (b) an inorganic filler, followed by paper-making to form a paper with a basis weight of 0.7 g/cm² or more. However, the oil absorbing papers disclosed in these patent publications still have a limited capacity to absorb oil or sebum and little indicating function as there is little change in opacity or color in the paper when oil is absorbed. Difficulty in confirming oil removal means that users of the oil clearing paper can not evaluate if or how much sebum is removed from the users' face when using the oil absorbing paper such that makeup and the like can be applied with confidence.

An oil absorbing paper for sebum is also disclosed in Japanese Examined Patent Publication (Kokoku) No. 56-8606, or U.S. Pat. No. 4,643,939, which describes a cosmetic oil absorbing paper produced by mixing hemp fibers with 10 to 70% by weight of polyolefin resin fibers and making a paper with a basis weight of from 12 to 50 g/cm². This paper will allegedly clear upon absorption of oil but still requires conventional papermaking techniques and would be rough to the touch. Japanese Unexamined Utility Model Publication (Kokai) No. 5-18392, discloses an oil absorbing synthetic paper comprising an oil absorbing paper with a smooth surface coating of inorganic or organic powder material such as clay particles, silica fine-particles, and powdered fibers. These oil-absorbing papers allegedly have some oil indicating effect by clarifying the paper upon oil absorption thus confirming oil absorption. However, the powder coating lowers the oil absorption capacity for these papers and it is still difficult to attain a clear change in the appearance of this type of oil clearing paper after oil absorption.

Japanese Unexamined Patent Publication (Kokai) No. 9-335451 (WO99/29220) discloses an oil wipe made of a porous thermoplastic film. This oil absorbing wipe film has higher oil absorption capacity than the oil absorbing papers and is also superior in confirming removal of oil following wiping as compared to oil absorbing papers. It is believed that the reason for this good oil removal indicating functionality is that these porous thermoplastic films exhibit low light transmittance before oil absorption because of irregular reflection of light, but the light transmittance increases substantially after the micro-pores of the film are filled with oils producing a large change in the film's opacity or light transmittance, and therefore appearance. This change in opacity clearly confirms to the user the removal of oil or sebum from his or her skin. Further, unlike the paper products, these film based wipes are soft, comfortable, smooth and nonirritating to the skin.

It is an object of the invention to provide an oil absorbing wipe having a rapid oil absorption indicating function, such as described in WO99/29220, which product can readily crumple for disposability and is easy to manufacture.

### BRIEF SUMMARY OF THE INVENTION

The invention is directed to oil absorbing wipe materials suitable for wiping a users' skin or hair. The wipes comprise at least an oil absorbing porous film-like substrate of a thermoplastic material formed using a nonparticulate filler. Generally, the wipe changes transparency or color (a change in L* of about 10 or more) when loaded with oil to provide an oil absorption indication functionality. The wipe material contains at least 38 percent of the nonparticulate filler and is capable of crumpling to 2.5 cm or less, as defined herein.

### DETAILED DESCRIPTION

The oil absorbent wipe is a porous filmlike thermoplastic material of a porous stretched or oriented film made of a thermoplastic material and a miscible nonparticulate filler. Filmlike as used herein is defined as thermoplastic films or consolidated nonwovens of thermoplastic fibers. The porous thermoplastic material can be coated on at least a portion of one face with an active agent. The wipe, whether used as is or with a coating, is preferably in a dry state, not wet, when used.

The porosity of the interstitial volume per unit area of the first preferred embodiment porous film material is preferably in the range of 0.0001-0.005 cm³ as calculated by the equation:

Interstitial volume per unit area=[film thickness (cm)×1 (cm)×1 (cm)×void content (%)]/100 (where the void content is the percentage of voids in the porous film).

The “void content” is more specifically defined as the percentage of an amount of filling material, when all of the voids of the porous film are filled with a material of the same composition as the film, with respect to a film with no corresponding voids. The void content of the porous film is preferably in the range of 5-50% and the thickness is preferably in the range of 5-200 μm.

The porous stretched film may be produced by various different methods using a thermoplastic material as the starting substance. A preferred method is described in U.S. Pat. No. 4,726,989, the substance of which is incorporated by reference in its entirety, where a porous film is formed by adding a miscible nonparticulate filler to a transparent crystalline thermoplastic resin, forming a film using conventional methods, such as blown extrusion or casting, and then stretching the film to create fine voids therein. A porous stretched thermoplastic film obtained in this manner has a large percentage of voids constituting the volume of the wipe compared to conventional paper oil cleaning wipes, and has excellent absorption of skin oils per unit area. Also, since the thermoplastic film has a structure with a uniform distribution of many fine voids, prior to wiping of skin oils from the skin surface it appears non-transparent due to light dispersion by the pore structures. However, after oil absorption the oils fill the voids or pores thus either preventing or reducing the degree of light dispersion. This together with the original opaque or transparent nature of the thermoplastic forming the film allows the oil absorbing effect to be clearly assessed by a change in transparency or opacity.

Examples of thermoplastic resins which can be used as the film forming material for production of the porous stretched thermoplastic film include, but are not limited to, polyethylene, polypropylene, polybutylene, poly-4-methylpentene and ethylene-propylene block copolymer. The nonparticulate fillers that can be used are generally non-volatile hydrocarbon liquids which for cost reasons generally are mixtures of liquids of various molecular weights. Lower molecular weight liquids are generally referred to as light to heavy mineral oils having a carbon chain length of at least about 20. The higher molecular weight liquids, sometimes referred to as semi-solids, are generally more viscous and are referred to as gels such as petroleum jelly or mineral jelly. The semi-solid materials generally have melting points (ASTM D-127) in the range of 30-70° C. The lower molecular weight liquids generally have pour points (ASTM D-97) in the range of 0° C. to −50° C. Examples of preferred nonparticulate fillers that can be used in combination with the aforementioned thermoplastic resins to provide the fine voids include, but are not limited to, mineral oils, petroleum jelly, and mixtures thereof. These nonparticulate fillers are preferred as they exhibit transparency upon absorption of oil. Generally, these fillers are liquids or gels in which the crystallizable polymer will dissolve to form a solution at the melting temperature of the crystallizable polymer, but will phase separate on cooling at or below the crystallization temperature of the crystallizable polymer. Preferably, these nonparticulate fillers have a boiling point at atmospheric pressure at least as high as the melting temperature of the crystallizable polymer.

Unexpectedly, it has been found that where the amount of nonparticulate filler used is 38-60% by weight, and more preferably 42-55% by weight of the starting thermoplastic material and other components of the wipe, substantially improved crumpability is obtained without adversely affecting the crumpability of the wipe. If the amount of filler added to the starting material is about 35% by weight or less, the crumpability of the film resulting after stretching is substantially reduced. But this cutoff is different for different nonparticulate fillers, with higher molecular weight liquid hydrocarbon nonparticulate filler, slight lower levels of filler can still provide the desired crumpability. The crumpability of the wipe is generally 2.5 cm or less and preferably 2.0 cm or less.

Other additives may also be added as necessary in addition to the thermoplastic resin and filler in the production of the porous stretched thermoplastic film. For example, organic acids such as carboxylic acid, sulfonic acid and phosphonic acid, and organic alcohols. As additional suitable additives there may also be mentioned, for example, inorganic and organic pigment, aromatic agents, surfactants, antistatic agents, nucleating agents and the like. In a preferred embodiment, the wipe can be made hydrophilic by suitable melt additives or a coating or surface treatment.

The nucleating agent is employed in the present invention preferably for inducing crystallization of the polymer from the liquid state and enhancing the initiation of polymer from the liquid state and enhancing the initiation of polymer crystallization sites so as to speed up the crystallization of the polymer. Thus, the nucleating agent employed must be a solid at the crystallization temperature of the polymer. Because the nucleating agent serves to increase the rate of crystallization of the polymer, the size of the resultant polymer particles or spherulites is reduced.

Examples of nucleating agents include aryl alkanoic acid compounds, benzoic acid compounds, and certain dicarboxylic acid compounds. In particular, the following specific nucleating agents have been found useful: dibenzylidine sorbitol, titanium dioxide (TiO₂), talc, adipic acid, benzoic acid, and fine metal particles.

The main starting materials and optional additives are melted and/or combined to form a film, producing a filler-containing thermoplastic film. The melting and mixing step(s) and the subsequent film forming step may be carried out according to known methods. An example of a suitable melt mixing method is kneading with a kneader, and examples of suitable film forming methods are the blown film method and the casting method. The blown film method, for example, can give tube-shaped films by melt mixing the main starting material, etc. and then blowing it up from a circular die. The casting method can give films by melt mixing the main starting material, etc. and then extruding it from a die onto a smooth or patterned chilled roll (cold roll). In a modified form of this casting method, the nonparticulate additives and/or fillers may be removed by washing off or extracting with a suitable solvent after extrusion of the melted mixture onto the chilled roll.

The formed thermoplastic film is then stretched to provide it with fine voids. As with the film forming, the stretching may also be carried out according to known methods, such as uniaxial stretching or biaxial stretching. For example, in the case of biaxial stretching, the stretching in the lengthwise direction may be accomplished by varying the speed of the driving roll, and the stretching in the widthwise direction may be accomplished by mechanical pulling in the widthwise direction while holding both ends of the film with clips or clamps.

The conditions for the film stretching are not particularly restricted, but the stretching is preferably carried out so as to give a void content in the range of 5-50% and a stretched film thickness in the range of 5-200 μm. If the void content upon stretching of the film is under 5% the amount of oil absorption will be reduced, while if it is over 50% the amount of oil absorption will be too great, making it difficult to clearly assess the oil absorbing effect. Also, if the film thickness is under 5 μm the amount of oil absorption capacity will be too low and the film will tend to adhere to the face making it more difficult to handle, while if it is over 200 μm the amount of oil absorption capacity will be too great and the film may feel stiff and harsh against the user's skin.

The stretching ratio for the thermoplastic film is usually preferred to be in the range of 1.5 to 3.0. If the stretching ratio is under 1.5 it becomes difficult to achieve a sufficient void content for oil absorption, while if it is over 3.0 the void content could become too large, causing too much oil absorption.

The average size of the voids formed by stretching of the film is usually preferred to be in the range of 0.2 to 5 μm. If the void size is under 0.2 μm it becomes impossible to rapidly absorb enough skin oil to create a clear change in transparency, while if it is over 5 μm the amount of oil absorption needed to permit a visible change in transparency may be too great.

As mentioned above, the interstitial volume per unit area of the porous stretched thermoplastic film obtained by the stretching process described earlier is preferably in the range of 0.0001-0.005 cm³, and more preferably in the range of 0.0002-0.001 cm³, as calculated by the equation defined above. If the interstitial volume of the film is under 0.001 cm³ it becomes difficult for the user to hold the oil cleaning wipe, while if it is over 0.005 cm³ the amount of oil absorption is too great, and it becomes difficult to clearly assess the oil absorbing effect.

If the original opacity is inadequate to produce a significant enough change in opacity, opacifying agents such as silica, talc, calcium carbonate or other like inorganic powders can be used at low levels. Such powders could be coated on the surface of the wipes or incorporated into the web structures. Suitable methods for incorporating opacifying agents into the web include that taught in U.S. Pat. No. 3,971,373 where a stream of particles is entrained into two separate converging melt-blown microfiber streams prior to collection. Another method of incorporating particulates is taught in U.S. Pat. No. 4,755,178 where particles are introduced into an airstream that converges into a flow of melt-blown microfibers. Preferably, only a small amount of such opacifying agents are included as they have the tendency to detract from the wipe softness.

The invention oil absorbent wipes are generally characterized by the ability to change from opaque to translucent after absorbing only a moderate amount of oil, such as would be present on a person's skin (e.g., from 0 to 8 mg/cm²). The oil absorbent wipes are particularly useful as cosmetic wipes as after absorbing skin oil at the levels excreted from common sebaceous glands, they will turn translucent, thus indicating that the undesirable oil has been removed and that makeup or other skin treatments can be applied. The oil-indicating effect is provided by the oil absorbing wipe which generally changes in L* by about 10 or more units, with a relatively low level of oil loading (e.g., 6 mg/cm² or less). The oil absorbing wipe is generally used as a single layer of the porous filmlike material but could be laminated to fibrous web materials, or films or the like.

The invention oil absorbing wipes are generally provided in a dispensable package of oil absorbing wipes of a filmlike thermoplastic porous material. The individual wipes are in the package in a stacked arrangement. By stacked it is meant that a face of one wipe will be over all, or substantial portion of one face, in continuous contact with all, or a substantial portion of, a face on an adjacent wipe in the package. Generally, the package will contain at least 2 or more individual wipes, preferably 10 to 1000.

The individual discrete wipes can be of any suitable size, however, generally for most applications the wipes would have an overall surface area of from 10 to 100 cm², preferably from 20 to 50 cm². As such, the wipes would be of a size suitable for insertion in a package, which could easily be placed in the user's purse or pocket. The material forming the dispensable containers is generally not of importance and can be formed of suitable papers, plastics, paper film laminates and the like. The shape of the tissues is generally rectangular; however, other suitable shapes such as oval, circular or the like can be used.

The oil-absorbing wipes of the invention can contain or be coated with any suitable active or nonactive ingredients or agents. Additional ingredients can comprises a wide range of optional ingredients. Particularly useful are various active ingredients useful for delivering various benefits to the skin or hair during and after oil removal and cleansing.

The coating compositions can also comprise a safe and effective amount of one or more pharmaceutically-acceptable active or skin modifying ingredients thereof. The term “safe and effective amount” as used herein, means an amount of an active ingredient high enough to modify the conditions to be treated or to deliver the desired skin benefit, but low enough to avoid serious side effects, at a reasonable benefit to risk ratio within the scope of sound medical judgment. What is a safe and effective amount of the active ingredient will vary with the specific active ingredient, the ability of the active ingredient to penetrate through the skin, the age, health condition, and skin condition of the user, and other like factors.

### Test Methods

Ability to Crumple Into a Ball

The ability to be crumpled or crushed into a ball for disposibility was measured using the following procedure. A 10 cm by 10 cm sample was cut from the web and crumpled by hand by rolling between ones fingers and palm to form a tight ball of approximately 1.5 cm diameter. The ball was placed on a flat surface and allowed to relax for 15 seconds. The diameter of the resulting ball was then measured. If the sample did not retain the ball shape and opened up, the observation was recorded as did not hold ball

Oil Absorption Capacity

The oil absorption properties of the films were measured using the following procedure. A 10 cm by 10 cm sample was cut from the web and weighed to the nearest 0.001 gram. The sample was dipped into a pan filled with white mineral oil. The sample was removed from the pan after one minute. The excess oil on the surface of the sample was carefully wiped off using tissues. The sample was then weighed to the nearest 0.001 gram. 3 replicates were tested and averaged. The Oil Absorption Capacity was calculated by: (D₁-Dₒ)/A (mg/cm²), where Dₒ=initial sample weight (mg), D₁=sample weight after dipping (mg) and A=sample area (cm²).

Oil Clear Time

The ability of the films of the invention to absorb oil and rapidly change color was determined by the following procedure. A drop of mineral oil was placed on the sample. The time required for the film to completely change color was measured by an observer using a stopwatch and is reported in Table 1 in seconds.

### COMPARATIVE EXAMPLE C1

A microporous film was prepared similar to that described in PCT application WO99/29220 Example 1, having the following composition: polypropylene (71.6%, Union Carbide Co. 5D45), mineral oil (28%, white oil #31, Amoco Oil and Chemical Co.), red iron oxide pigment concentrate (0.3%, Americhem), nucleating agent (0.04%, Millad 3988, Milliken). The microporous film had a thickness of approximately 38 microns.

### COMPARATIVE EXAMPLE C2

A microporous film was prepared similar to that described in PCT application WO99/29220 Example 1, having the following composition: polypropylene (63.75%, Union Carbide Co. 5D45), mineral oil (35%, white oil #31, Amoco Oil and Chemical Co.), red iron oxide pigment concentrate (0.3%, Americhem), nucleating agent (0.95%, Millad 3988, Milliken). The microporous film had a thickness of approximately 38 microns.

### EXAMPLE 1

A microporous film was prepared similar to that described in PCT application WO99/29220 Example 1, having the following composition: polypropylene (53.6%, Union Carbide Co. 5D45), mineral oil (45%, white oil #31, Amoco Oil and Chemical Co.), red iron oxide pigment concentrate (0.3%, Americhem), nucleating agent (1.15%, Millad 3988, Milliken). The microporous film had a thickness of approximately 38 microns.

### EXAMPLE 2

A microporous film was prepared similar to that described in Example 1, having the following composition: polypropylene (53%, Union Carbide Co. 5D45), mineral oil (42%, white oil #31, Amoco Oil and Chemical Co.), and phthalo blue pigment/nucleator concentrate (5%, PPN 71512 80:20 polypropylene: pigment, Tokyo Printing Ink Corp.). The microporous film had a thickness of approximately 38 microns.

### EXAMPLE 3

To demonstrate the use of petroleum jelly as a nonparticulate filler, a microporous film was prepared similar to that described in Example 1, having the following composition: polypropylene (56.5%, Union Carbide Co. 5D45), petroleum jelly (38.5%, FONOLINE Super White, Crompton Corp., Greenwich, Conn.), and phthalo blue pigment/nucleator concentrate (5%, PPN 71512 80:20 polypropylene: pigment, Tokyo Printing Ink Corp.). The microporous film had a thickness of approximately 38 microns.

### EXAMPLE 4

To demonstrate the use of petroleum jelly as a nonparticulate filler, a microporous film was prepared similar to that described in Example 3, having the following composition: polypropylene (53%, Union Carbide Co. 5D45), petroleum jelly (42%, FONOLINE Super White, Crompton Corp., Greenwich, Conn.), and phthalo blue pigment/nucleator concentrate (5%, PPN 71512 80:20 polypropylene: pigment, Tokyo Printing Ink Corp.). The microporous film had a thickness of approximately 38 microns.

Table 1 below shows that by increasing the oil content of the base film, the film can now be crumpled into a small diameter ball for disposal. The Oil Absorption Capacity and the Oil Clear Time (i.e., the time it takes to change color or clear the film after absorption of facial sebum) were also shortened considerably as compared to the comparative examples that have a lower oil content.

TABLE 1

| | | | Oil Abs. | Oil |
|---|---|---|---|---|
| | % Diluent | Ball Diameter | Capacity | Clear Time |
| Film | in film | (cm) | (mg/cm²) | (sec) |
| C1 | 28 | 4.3 | 1.18 | 3.6 |
| | | (did not | | |
| | | hold ball) | | |
| C2 | 35 | 3.5 | 1.42 | 2.4 |
| | | (did not | | |
| | | hold ball) | | |
| 1 | 45 | 1.7 | 1.61 | 0.8 |
| | | (balled) | | |
| 2 | 42 | 2.3 | | 4.0 |
| 3 | 38.5 | 2.5 | | 9.0 |
| 4 | 42 | 2.5 | 1.46 | 7.7 |

We claim:

1. An oil absorbing wipe suitable for wiping a users skin or hair comprising an oil absorbing porous film-like substrate of a crystalline thermoplastic material with a nonparticulate filler which porous substrate changes transparency or color when loaded with oil, the porous substrate having an amount of nonparticulate filler of greater than 40 percent based on the amount of filler and thermoplastic material; the wipe having the ability to crumple to 2.5 cm or less, for a 10 by 10 cm wipe.

2. The oil absorbing wipe of claim 1 wherein the amount of nonparticulate filler is from 38 to 60 percent by weight of the wipe.

3. The oil absorbing wipe of claim 1 wherein the nonparticulate filler is a liquid hydrocarbon.

4. The oil absorbing wipe of claim 3 wherein the thermoplastic material is polypropylene.

5. The oil absorbing wipe of claim 4 wherein the wipe amount of nonparticulate filler is 42 to 55 percent by weight of the wipe.

6. The oil absorbing wipes of claim 5 wherein the nonparticulate filler is a lower molecular weight hydrocarbon.

7. The oil absorbing wipes of claim 2 wherein the nonparticulate filler is a higher molecular weight liquid hydrocarbon.

8. The oil absorbing wipe of claim 1 wherein interstitial volume per unit area of said porous stretched film is in the range of 0.0001-0.005 cm³ as calculated by the following equation:
interstitial volume per unit area=[film thickness (cm)×1 (cm)×void content (%)]/100 (where the void content is the percentage of voids in the porous film).

9. The oil absorbing wipe of claim 8 wherein the void content of said porous stretched film is in the range of 5-50% and the film thickness is in the range of 5-200 μm.

10. The oil absorbing wipe of claim 8 wherein the porous film voids have an average size in the range of from 0.2 to 5.0 microns (μm).

11. The oil absorbing wipe of claim 9 wherein the interstitial volume per unit area is from 0.0002 to 0.001 cm³.
